(19) United States
(12) Patent Application Publication
(10) Pub. No.: US 2006/0092476 A1
(43) Pub. Date: May 4, 2006

(54) Document with user authentication

(76) Inventor: David Hilton, Glos (GB)

Correspondence Address: SYNNESTVEDT LECHNER & WOODBRIDGE LLP, P O BOX 592, PRINCETON, NJ, 08542-0592, US

(21) Appl. No.: 10/537,110

(22) PCT Filed: Dec. 11, 2003
(86) PCT No.: PCT/GB03/05413

§ 371 Date: Jun. 2, 2005

(30) Foreign Application Priority Data
Dec. 12, 2002 (GB) 0228955.1

(51) Int. Cl. G06Q 99/00; H04K 1/00; G06K 15/00

(52) U.S. Cl. 358/3.28; 705/67

(57) ABSTRACT

A document (e.g. a check) for a specific beneficiary has encoded on it a unique identifier, also present on an identity card owned by that beneficiary. A person presenting the document (e.g. to cash the check) also has to show their identity card. A check can then be made between the unique identity on the document (associated with the true beneficiary) and that obtained from the identity card in order to authenticate the person claiming to be the true beneficiary.

### FIELD OF THE INVENTION

This invention relates to a document that comprises beneficiary authentication data. A document is any item which carries information. A beneficiary is a person or entity that benefits in some manner because of the document. An example would be a document that is a cheque (i.e. a bill of exchange drawn on a bank by a holder of an account at that bank) made payable to a beneficiary who is the payee. The cheque includes supplemental payee authentication data.

### DESCRIPTION OF THE PRIOR ART

Cheque fraud is an increasing threat to the operation of the banking systems in many countries.

A large amount of fraud takes place by falsification of the payee name and the amount on cheques. This is frequently done by means of “cheque washing”, carried out by using a solvent to wash off the original printed characters, enabling the fraudster to replace them with new printed characters (e.g. his own name). An implementation of this invention is concerned with cheques that are fraudulently acquired and cashed at remote outlets such as cheque cashing agencies. The challenge is to authenticate the person who presents the cheque (i.e. confirm the identify of in order to verify entitlement: is the payee named on the original cheque the same person who is representing himself as the payee at the cheque cashing agency?). According to one authority, “Experience in the banking industry finds that aggressively checking identification would reduce bank fraud losses in large banks by 40%”.

Currently, identity is frequently established by the use of drivers' licences, social security cards or other documentary means. But if person X has had a cheque made payable to him stolen, then it is possible that fraudulent person Y will ‘wash’ off name X printed on the cheque and replace it with his own. (Fraudulent payee Y can then cash the cheque, using his valid drivers license as identification. Fraudulent person Y may not even bother to change the payee name, but instead rely on not being asked to authenticate himself or in having some false identity document in the name of person X.)

One conventional solution to this is to embed data into the document to make the document self-authenticating. For example, the payee name and amount can be encoded and that data printed onto the document in an encrypted form. When the cheque is presented for cashing, the encrypted data can be read out, decrypted and the payee name and amount compared with the payee name and amount printed on the cheque. Because a fraudulent person should not be able to encode and encrypt an altered name or amount onto the cheque, this procedure is reasonably robust. However, if the fraudster has stolen an identification document belonging to the true beneficiary, he can pose as him and will not need to alter the cheque at all.

A parallel thread to the above problems is that the reliable establishment of identity has become a more prominent issue with the recent anxiety over terrorism and identity theft, and research into more effective means is ongoing. Biometric techniques have been refined, moving beyond the long established fingerprint recognition through to methods such as iris recognition (techniques being pursued by the Federal Aviation Authority (FAA) for instance.) Biometric identification parameters have been encoded onto identity cards in various forms including the use of machine readable chips. However, identity documents that offer sophisticated and secure methods of verifying the name etc. of a person would still offer no bar to the simple technique of cheque washing, since the fraudulent person can replace the true payee name with his own, and then present the cheque with payee name altered to his own name and support that with his own identification document.

### SUMMARY OF THE INVENTION

In a first aspect, there is a document which comprises the name of an ostensible beneficiary in human readable form, together with machine readable encoded data that can be decoded to generate a unique identifier, the unique identifier also being a function of unique data present in a human readable form on an identification item carried by a true beneficiary of the document-, but having no simple functional relationship to any data on the document, such that the ostensible beneficiary of a document can be authenticated by comparing the unique identifier obtained from the document with the unique data on the identification item provided by the ostensible beneficiary.

Where the document is a cheque, then the invention enables the authentication (e.g. verification of entitlement) of (a) whether the person presenting the cheque is the person named on the original cheque and also (b) whether the original cheque itself has been tampered with by altering the payee name. Prior art systems that require the person to show an ID that matches with the name on the cheque address problem (a) but not (b). Prior art self-authentication systems address problem (b) but not (a).

This implementation meets the need for a simple and low-cost solution to cheque tampering. For example, in one implementation, the security of cheque cashing operations at offline agencies is enhanced by printing an encoded form of personal identification onto cheques. The unique data could be a social security number, so that at a cheque cashing store or other kind of offline agency, the cashier would simply have to read off the encoded version of the social security number from the cheque using a simple and low cost reader with a simple decoding engine (requiring no on-line connection), have that number displayed at a cash till or computer and then compare that number with the number written on the identity card or social security card presented by the ostensible beneficiary, plus (ideally) make a visual comparison between the appearance of the ostensible beneficiary and his photograph on the social security card. This represents a simple, easy to use and reliable way of ensuring that cheques are cashed only to the true beneficiary as named on the original cheque. A fraudster cannot simply wash the payee name off and replace it with his own, since the unique identifier obtained from the cheque itself (and associated with the true beneficiary) will not match (or otherwise correspond to) the unique data obtained from the fraudster's identification item.

### DETAILED DESCRIPTION

The invention aims to capitalise on and leverage off the various forms of documentary identification items in use by encoding onto cheques data that relates to an identification item. This unique data may be a driver's licence number, the social security number (SSN) or some data referring to a biometric measurement that appears on or is derivable from the identification item. An identification item is any object that carries identification information. It may be a printed document (identification card, passport, social security card, drivers licence etc). Because the invention ties authentication of a beneficiary named in a document to an identification item associated with that beneficiary, it enables identification to be made at outlets which do not have online access to further information. Further, since many identification items contain secured images of the relevant person, this gives rise to greater confidence in their authenticity. Identification of a customer is achieved by a sales person simply scanning in the customer's cheque using normal bar code scanning point of sale equipment; that equipment then decodes and displays (on the cash register display) the identification data, which the sales person can then easily compare with the identification data printed on an identification item presented by the customer to the sales person. Ideally, the identification item should include an identity photograph so that the sales person can check that the identification item itself appears to be owned by the person presenting it.

Increasingly, identification items are to be protected by the use of biometric data which is stored in some form of memory chip secured onto the item. Typically, an adequate representation of a fingerprint can be stored in roughly 200 bytes of data. The code added to a cheque might contain the whole of that data or might simply contain a digest of the data with sufficient bits to be unique to all intents and purposes. Thus a 20 bit digest would be provide more than a million possible configurations. The currently popular iris recognition identification provides another possible form of biometric representation and again the whole or part of the data may be added to a cheque. Where biometric data is used as the unique data, some form of automatic comparison between the biometric data encoded on the document with that obtained from the identification item is useful: this may involve scanning the document to extract the encoded biometric data and also scanning the identification item to extract the biometric data encoded in it. The ultimate extension of this is for the identification item to be a part of the human body from which the biometric data is derived—e.g. an iris or fingerprint. Then, an automatic iris scanner or fingerprint reader at the cheque cashing outlet etc. can be used to extract the biometric data from the ostensible beneficiary.

To encode the identification data, the cheque itself can be printed with a conventional 1 or 2D barcode or more sophisticated symbologies, such as those available from Enseal Systems Limited and disclosed in PCT/GB02/00539. In this way, a fraudulent person presenting the cheque for payment cannot simply replace the true payee's name with his own and present his own drivers license etc. as proof of identity, since the encoded drivers license data on the cheque will not match that from the fraudulent payee's actual license.

In effect, the cheque has encoded onto it a reference to a more complicated set of data relating to an individual, where the data itself would require a far larger payload than is feasible in a simple printing process on a limited area of a cheque.

The printing of identification data is carried out in general at the same time as the printing of the customised variable data onto the cheque, using one of the range of symbologies which has been developed for ease of machine reading, in a manner that will not degrade the workflow unduly. Typically the cheque printing will be part of a large payroll operation in which the employer has data such as SSN's on a database so that the whole process is easily automated. However, the same system could be used for individual printing, as, for instance, a doctor printing a prescription intended for a particular person where the doctor is likely to have access to various forms of personal information about that person.

The security of the information which is printed onto the cheque need not be compromised. If, for instance, an SSN were to be used, it could be transformed with a one way hash function before being encoded. It would be difficult for a fraudster to falsify a SSN to match a hashed value since hashes are essentially irreversible. At the receiving outlet the software would calculate the same hash and compare the values without revealing what the values actually were. Hence, the person presenting a cheque for encashment would type in his SSN on a keypad at the point of sale and this would be hashed to generate the value which is compared with the value obtained when scanning the cheque.

Equally the unique data (e.g. SSN) might be combined with a date, account number or other variable to ensure that it did not always appear in the same format on the document. A further enhancement of security could be achieved by using the unique data as a key to some form of encryption of the unique data.

The use of printing by instruments such as ordinary lasers is to be compared with systems such as those used with ATMs, where data is added to a cheque card in the form of the modification of a magnetic stripe. Another important distinction with the ATM method is that the verification of identity at ATMs is based upon a PIN number which is a function of the account number encoded onto the cheque card. The present invention concerns data added onto a cheque which has no simple functional relationship to any data contained on the cheque. There will be no means of deducing the encoded identifier from the payee name or account number without actual access to the item (which will be some form of a document, as that term is defined in this specification) being used for identification.

One extension would be that a code word (e.g. dog's name, favourite drink etc) should be scrambled using a PIN and added to the ID card in machine readable form. At a point where identification takes place the person concerned types in the PIN and the code word and the software determines from a scan of the ID card whether there is a match.

The point is that a fraudster would have try out all possible PINS and all possible code words in order to defeat the system. In effect it is using a very long PIN number, where the code word would be an object that is easy to memorise. The advantage is that there would be no real way for a fraudster to know when the data was correctly unscrambled. In fact, the same system could be used on the cheque using a code word, scrambled by a PIN, which could be a driver's licence number.

Another use for the present invention is to authenticate tickets, stamps or other indicia issued by a third party to an end-user and printed by that end-user. Then, the end-user/customer could pass to the vendor their unique data (e.g. passport number etc.) which could be hashed and printed on the ticket etc. When the ticket etc. was due to be used the passport etc. would have to be produced.

A further use is to authenticate the user of a credit/debit/charge card. These cards could include, as the unique identifier, a hashed, encoded version of unique data taken from an identification item (e.g. a photo ID card). Then, use of a credit etc, card at a retail outlet etc. would require the end-user to show the identification item as well as supply the credit card. The salesperson would swipe/read off data from the credit card in the normal way to pay for the goods, but would also read off the unique identifier and compare that with the unique data on the photo ID card.

1. A document which comprises the name of an ostensible beneficiary in human readable form, together with machine readable encoded data that can be decoded to generate a unique identifier, the unique identifier being a function of unique data present in a human readable form on an identification item carried by a true beneficiary of the document, but having no simple functional relationship to any data on the document, such that the ostensible beneficiary of a document can be authenticated by comparing the unique identifier obtained from the document with the unique data on the identification item provided by the ostensible beneficiary.

2. The document of claim 1 in which the document is a cheque and the ostensible beneficiary is the payee named on the cheque.

3. The document of claim 1 in which the machine readable encoded data is printed onto the document as a 1 or 2D bar code or other form of graphical symbology.

4. The document of claim 3 in which the machine readable encoded data can be scanned by a bar code scanner.

5. The document of claim 1 in which the document is selected from the following list of document types:
(a) prescription for medicine;
(b) tickets
(c) tickets, stamps or other indicia issued by a third party to an end-user and printed by that end-user
(d) credit, charge or debit card.

6. The document of claim 1 in which the identification item is selected from the following list of document types:
(a) identification card or other form of document
(b) passport
(c) drivers license
(d) document printed with biometric data
(e) iris
(f) finger

7. The document of claim 1 in which the identification item comprises a photographic image of the true beneficiary.

8. The document of claim 1 in which the machine readable encoded data is related to the unique data by a one way hash function.

9. The document of claim 1 in which the machine readable encoded data does not always appear in the same format in different documents associated with the same beneficiary.

10. A method of authenticating an ostensible beneficiary presenting a document, in which the document comprises the name of the ostensible beneficiary in human readable form, together with machine readable encoded data that can be decoded to generate a unique identifier, the unique identifier also being a function of unique data present in a human readable form on an identification item carried by a true beneficiary of the document, but having no simple functional relationship to any data on the document, comprising the step of:
comparing the unique identifier obtained from the document with the unique data on the identification item provided by the ostensible beneficiary.

11. The method of claim 10 in which the document is a cheque and the ostensible beneficiary is the payee named on the cheque.

12. The method of claim 10 in which the machine readable encoded data is printed onto the document as a 1 or 2D bar code or other form of graphical symbology.

13. The method of claim 12 in which the machine readable encoded data can be scanned by a bar code scanner.

14. The method of claim 10 in which the document is selected from the following list of document types:
(a) prescription for medicine;
(b) tickets
(c) tickets, stamps or other indicia issued by a third party to an end-user and printed by that end-user;
(d) credit, charge or debit card.

15. The method of claim 10 in which the identification item is selected from the following list of document types:
(a) identification card or other form of document
(b) passport
(c) drivers license
(d) document printed with biometric data
(e) iris
(f) finger

16. The method of claim 10 in which the identification item comprises a photographic image of the true beneficiary.

17. The method of claim 10 in which the machine readable encoded data is related to the unique data by a one way hash function.

18. The method of claim 10 in which the machine readable encoded data does not always appear in the same format in different documents associated with the same beneficiary.
